(19) United States
(12) Patent Application Publication
(10) Pub. No.: US 2021/0004926 A1
(43) Pub. Date: Jan. 7, 2021

(54) SYSTEM AND METHOD FOR INTEGRATING IMPROVED SUBSTITUTE TEACHING WITH TARGETED VIRTUAL LEARNING

(71) Applicant: Scott Foster, Ardmore, OK (US)

(72) Inventor: Scott Foster, Ardmore, OK (US)

(21) Appl. No.: 16/813,724

(22) Filed: Mar. 9, 2020

Related U.S. Application Data
(60) Provisional application No. 62/816,101, filed on Mar. 9, 2019.
(60) Provisional application No. 62/824,280, filed on Mar. 26, 2019.

(51) Int. Cl. G06Q 50/20; G09B 5/06

(52) U.S. Cl. CPC G06Q 50/205; G06Q 20/10; G09B 5/065

(57) ABSTRACT

A method for delivering remote instructional services for educational institutes and learning groups, including setting qualifications for a substitute assignment of instruction at the educational institute or group, soliciting instruction services from at least one qualifying instructor for a substitute assignment, achieving an agreement with the qualifying instructor to deliver a substitute assignment to at least one audience member, arranging the delivery of instructional services by instructors to at least one audience member by video streaming and paying a fee for the instruction to the qualifying instructor or its agent.

### RELATED APPLICATIONS

This application claims priority from U.S. Provisional Application No. 62/816,101 filed on Mar. 9, 2019, entitled “System and Method for Educational Integration of Gaming,” and claims priority from U.S. Provisional Application No. 62/824,280 filed on Mar. 26, 2019, entitled “Improved Educational Delivery System,” the entire contents of which are hereby fully incorporated herein.

### BACKGROUND OF THE INVENTION

The invention relates to an improved method and system for improve curriculum and modern learning platforms in learning institutions such as Pre-K through College. The invention further relates to improving substitute teaching practices. The invention even further relates to integrating online learning to classroom teaching. The invention even further relates to a method for giving educators control over more versatile forms and experiences for which students achieve learning objectives and skills both on campus and off campus.

### 1. Field of the Invention

The present invention relates to the fields of providing education services in classroom and through on-line systems. The present invention further relates to designing educational programming that cooperatively interfaces with virtual student profiles. The present invention even further relates to a system of integrating skills and learning-based curriculum to selecting substitute or alternative teachers from qualified groupings, the system to be accessible on computers and other personal devices.

### 2. Description of Related Art

The idea of delivering educational content through online learning systems is well known in the arts, and in some contexts students and parents can create customized learning strands that may somewhat reflect objectives taught at schools. Similarly, schools have long provided substitute teachers, drawn from pools of locally-based retired teachers or suboptimally, from uncertified stand-ins. Online teaching has been utilized in other contexts, from national audiences to streaming existing classroom instruction.

Educational service providers however, remain plagued with resolving issues with ensuring continuity in meeting learning objectives from an absent teacher to a substitute. With more emphasis in ensuring that sick students and instructors do not remain in a classroom, educational institutions experience difficulties in delivering ideal testing results from students given this atmosphere. Studies show on average over a typical 13 year secondary education, a public school student may spend one full year with a substitute instructor. Another study suggests that up a great deal of learning progress is lost when a long-term substitute replaces a regular teacher. Educational institutes have estimated that $5 billion dollars are lost per year in funding and additional costs because substitute teachers are either not given needed tools to deliver a quality learning experience or are not qualified to do so. Though companies exist to provide online learning tools, they are often underutilized because of set-up costs and labor, and are utilized only for remedial students rather than the general population as a standard. Such online learning providers may support existing educational standards, but there remains a lack of coordination with the day-to-day educational experience of the student, parents or student stakeholders, teacher and administrators, and especially in the context of substitute teaching.

There exists a need to improve curriculum and learning strategies and create an advanced modern learning platform in schools, colleges, and institutions across the US and around the world. There further exists a need for new, creative, and fresh approaches to learning for today's population and technology seeking society. The need also demands buy-in from students, caregivers, parents, and staff for true and total collaboration, excitement, and control. To accomplish this, education service providers update its delivery of education. There further exists a need to meet the reality that students of today have acquired the need for constant digital. There further remains a need to standardize the means by which students can learn yet customize the level at which they learn, as students often must cycle through different teachers, substitutes (without appropriate training and certification in many areas), or first year teachers not having contract renewed for poor/lack of performance. There remains a need to avoid leaving children to suffer in their academic progress with outdated and limited learning and with untrained temporary substitutes filling major roles. There remains a need to for students who prove to learn best through certain learning styles to have continued opportunities to further grow academically and educationally through those learning styles. Thus, there remains a further need to bolster emergency certified positions in schools who cannot find enough teachers which lowers the education quality.

### SUMMARY OF THE INVENTION

These and other objects were met with the present invention.

In a first embodiment, the system and method may comprising a establishing a user profile comprising information relevant to the user including educational skill levels, testing information, and a learning path; an administrative control panel for setting rules for each user's interfacing with the system; qualifying curriculum standards, grade and other subset level settings, skill level, and individual learning needs; the system further comprising a group of user accounts having similar profiles to create similar profile types. The method may further comprise delivering remote instructional services for educational institutes and learning groups, including setting qualifications for a substitute assignment of instruction at the educational institute or group, soliciting instruction services from at least one qualifying instructor for a substitute assignment, achieving an agreement with the qualifying instructor to deliver a substitute assignment to at least one audience member, arranging the delivery of instructional services by instructors to at least one audience member by video streaming and paying a fee for the instruction to the qualifying instructor or its agent.

In a second embodiment, a method for creating a remedial online class may comprise creating a digital record of a student's past classes taken, notifying a student of a remedial class opportunity based upon filters of past classes taken by student, accessing at least one learning module, and updating the digital record of the student according to the successful completion of the remedial class.

### BRIEF DESCRIPTION OF THE DRAWINGS

A more complete understanding of the present invention may be derived by referring to the detailed description and claims when considered in connection with the Figures, where like reference numbers refer to similar elements throughout the Figures:

FIG. 1 depicts a diagram of the inventive method.

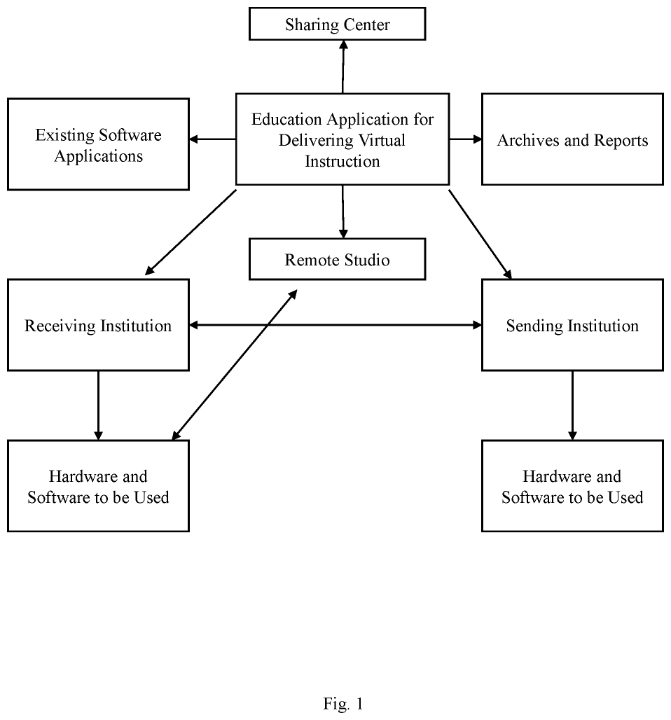

FIG. 2 depicts a diagram of the inventive system and method of providing virtual education services.

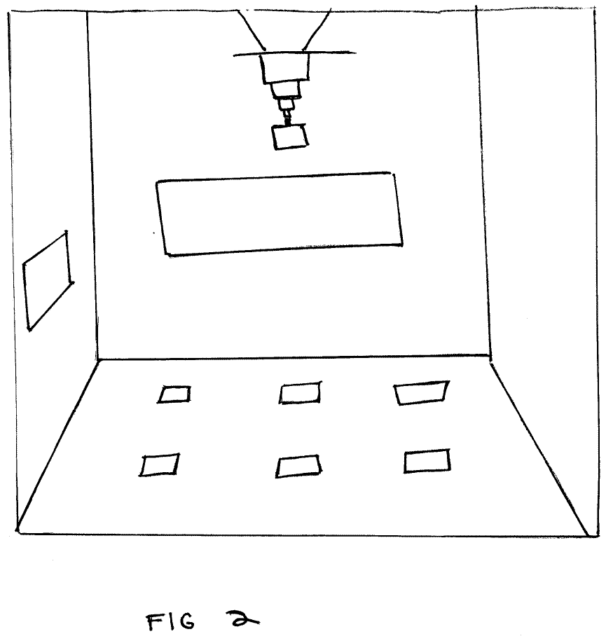

### DETAILED DESCRIPTION OF THE INVENTION

The present invention provides a system for integrating educational modules into a student profile database. The present invention provides administrative controls of online learning tools so that they may be delivered to users across a network or at home. There present invention provides a method for integrate a pool of qualified substitute teachers capable of delivering virtual classroom learning. These needs are met with the following system and method.

According to the illustrations provided, a method and system of adapting the system are disclosed for implementing existing popular gaming into an educational service provider's network, with administrative controls. User students and staff may have client accounts to access recreational games directly at the originating game access, or through a portal assigned to each user within the educational service provider's network. Users may earn access and continued access to recreational gaming through rules established by the administrators of the educational service provider. In an embodiment of the invention, access may be established by a user meeting one or more learning milestones, completed lessons, or other educational objective set by the administrator. In another embodiment, administrators of the inventive system may assign available games to groups of students, by parental permission, subject area such as math, science, letters, language, et al), by behavior, extracurricular involvement, academic performance, and other groupings of users. Users may be assigned computer hardware and/or VR accessories for gaming use, or log-in credentials that enable remote access outside of an existing lab or even the campus of the educational service provider.

To set up the inventive system within a school's network, it is within the scope of the invention to utilize off the shelf solution such as google classroom, google emails or other student management systems known in the arts to assign, store, or track student information. Such existing software could be used to import user information into the present inventive system stored locally on a server, or via server space contracted out to a 3^{rd} party. In an embodiment of the inventive system, administrators may request reporting of the user's game play, educational module performances, and other data generated through downstream use, rewards information. Such reporting may include time stamps and reports in and by their chosen delivery method, with optional rewards expiration dates if so desirable. After importing the student information into the inventive system, student profiles may be created automatically for all games to which students have been given access. Students may be given access to certain games according to any number of groupings and filters. Controls may be applied to the student's use of the accessed games, controlling the time allowed for use over a certain time period and other variables pursuant to each student's game play. Administration staff, teachers and other stakeholders may be given access to controls of the student game management suite, enabling the student to access as additional games upon achieving milestones. Factors outside of academic or curricula may be utilized in the game management suite for each student or for groups of students, according to other embodiments of the invention.

In an embodiment of the inventive process, an administrator may select a control or override within a recreational game so that a user may experience a set time countdown, such as a 30 second timer. The timer may notify user that he or she will need to switch over to educational module, lesson, or other learning objective. In other embodiments, time may be extended or shortened through administrative controls for selected variables. In other embodiments, the faster the user masters the skill, whether in a predictable learning path or one required by administrative control, the faster he or she returns to the recreational game. The administrator of the inventive system may set other rules that connect the user to the outside world. By way of example and not limitation, emergency alerts may be set for automatic or manual interruption or messaging to users, in event of fire, panic or other emergency event that requires the user's separation from game play. Administrators may also broadcast non-emergency messaging that does not interrupt game play, but rather scrolls or appears upon a display screen of the user's current computer/device.

The user or administrator(s) of the inventive system may pause the game to target instruction and start back up for peer interaction and group discussion and real-world examples. The inventive system may comprise building a playing field of selected users which may be separated or combined by state, state curriculum standards, grade, subject, county, etc. and automatically combining said criteria to create a citywide, countywide, statewide, national, or worldwide game based on grade, subject, education level, scores, etc. with many type of grouping based on many available criteria. In a related embodiment, a user may engage in online curriculum meets where students may compete against one another within a given subject.

In another embodiment of the invention, educational service providers may set up controls within the inventive system so that users may earn rewards including digital currency to use for desired or needed goods or services through the earned reinforcement of positive behavior or educational curriculum success. Such rewards may be given to users at selected times, for school-related accomplishments such as for daily attendance, grades, behavior, and other scholastic, leadership or athletic accomplishments. Students may be given control over the rewards to use, and/or administrators may have separate or concurrent control over the ability for rewards to be spent. Control variables for rewards may include temporal (such as daily) limits, per gameplay or summary game limits. Rewards may be optionally set to be available for use in the recreational gaming or educational modules, or in real life. In an embodiment of the invention, users may use rewards to purchase an avatar skin, clothing such as a jersey, accessories or other items/tools to wear in the game representing the user's school/colors or other signifier of school activity. In a related embodiment of the invention, a user who plays recreational games and is registered within the inventive system yet may have the opportunity for rewards and incentives as a result of activities taking place outside of the games and learning modules. For instance, rewards in the form of digital currency, gaming coins, tools, credits, skins, or other incentives may be earned as the user accomplishes a skill or grade at school, opens the door for someone, stops a fight, kind words for someone, helps someone on the bus, picks up trash, or other positive behavior by staff or other administrative stakeholders. Similarly, a user may lose coins or currency through poor behavior or performance according to rules set at administrative controls or through other agreement/consultation with user, parent, teachers, and other stakeholders. Rewards may further be purchased by students, relatives, friends, or other interested parties to the user's account through methods existing in the arts such as money transfer software applications.

In another embodiment of the inventive system, a user's school staff or leadership, teacher, friend, parent, or community member may further purchase and gift tokens/coins to students by purchasing, donations, sponsorships, and by other alternatives to basic currency transfers. The distribution of virtual prizes and currency may be set to auto transfer pending a future event, for set criteria attendance, grades, test, or semester grades, curriculum accomplishments and other scholastic, leadership and athletic achievements or milestones. In yet another embodiment rewards could further have real world replicas for users to display, such as oversized tokens, certificates, 3d printed objects that symbolize or represent the reward earned by the user.

In still another embodiment of this aspect of the invention, the distribution of rewards comprises type of digital currency (including cryptocurrency) for gaming/schools/public used in or out of schools. Users or students may utilize the digital currency for a purchase of i.e. concessions at a sporting event at home games or away, in the lunchroom, for library fees, yearbook purchases, purchasing items through advertising within the inventive system network, or at participating retail stores in the physical commercial world or via online retail. Admin controls may restrict the amount of purchasing by percentage or stated level. In another embodiment of the invention, the digital currency may be recognized and used within recreational games used to acquire coins, skins, awards and other access or micropurchase fees. The currency may reduce the need for users to carry cash and could be sold, traded, or used again. The digital currency could be set to expire within parameters set by the donor, earner, or administrator benefactor of the digital currency. In other embodiments, the digital currency may part of a closed financial environment that allows growth in value as uniquely designed and desired by amount, subject, year, person, and other parameters. In this embodiment, the virtual coin or currency may be assigned the attributes of the user who first earns it and/or successively possesses it, the reason for earning it, the person or policy responsible for assigning the virtual coin or currency to the user, location of the owners and assigners, and other metadata surrounding the initial creation of that specific unit of currency. Such metadata of the virtual coin and currency may be carried forward in future exchanges between users and others, so that the value of the currency could have an intangible value outside of the stated monetary value for highly sought or even sentimental attributes. For student users, having future access to this metadata could provide sentimental and useful information that captures memories in the learning institution. Useful information could comprise contact information, for example, to give users the means to recall and update donors or track other rewards by user.

Users may be assigned a secure storage locker to store digital assets accumulated through use of the inventive system, in another embodiment of the system. Additional security measures such as biometric, multi-step authentication or other credentials may be required to access, share and utilize such assets. Rewards may be kept in the box, with the ability for 3^{rd} party auditing of the rewards, including digital currency, to be checked in or out of the secure storage locker. Users may further store transcripts, honors, awards, and other digitally-available assets that user may opt to share with recipients. Users may further store photos and other personal files and data as needed.

In yet another embodiment of the invention, schools or other academic institutions may control access within the platform and set rules that, for instance, ensure that first graders are only playing 1st graders from across the US. Schools may set user profiles by email, or login name, IP or MAC range or other subset requirements.

In another embodiment of the invention, the system may comprise an immediate ranking feedback for users. Admin controls may selectively, progressively, or alternatively create a ranking dashboard so that users may use personal computing devices to display standardized scores by school, city, state and nation. In an alternative embodiment, the GUI of the ranking display screen may resemble popular recreational gaming score rankings. In practice, users may track academic and educational progress as a student selected peer group as they compare to other education scores and learning strands. In a related embodiment, for example, placement for subject tests may only occur during school hour with social interaction and tutoring turned off, so that traditional controls for ensuring fair and accurate test taking are maintained.

In yet another embodiment of the inventive system, administrators may selectively enable network wide recognition for users reaching certain benchmarks in a recreational game, such as winning or skill mastering, field, subset, skill, test, and other milestones as set by the administrator, teacher, or other stakeholders. As carried out in use, if a pre-set milestone is met, a notification may be sent administrators office (such as a superintendent, counselor, teacher or principal's office) showing user about to win a recreational Player versus Player tournament, master a recreational game or educational learning strand, field, subset, skill, test or other milestone/achievement. The notification in embodiments of the invention may comprise textual, audio or video alerts. In the case of video, content may be delivered to via streaming applications such as twitch, stream, Instagram, or others selected from a user's dashboard or from administrative controls. An administrator or agent thereof could then opt to feed selected office televisions, monitors, or live social media feeds to stream for other users to watch the final ending while cheering on students. In other embodiments, other student users may comment in game or educational skill challenge as the user turns on twitch or other streaming. In still other embodiments, the highlight streaming mechanism be set to stream automatically start within set parameters, and may further comprising auto inviting or distributing to each user's selected recipients.

In yet another embodiment of the invention, users and parents/other stake holders may select learning an educational skill such as algebra or English from selected from rated teachers in the county, state, or even US. User students or parents may control selection of the teacher, tutor, or mentor according to selected criterion such as other interests of the user, any learning challenges or preferences of the user, and accomplish or master a subject without being bound by location, poverty level, house quality, parental income, social status, etc. In an embodiment of the invention, users or parents/stakeholders of the user may opt to pay or tip an educator or tutor with virtual coins by students, admin, or parents for helping one succeed. In embodiment where the user is algorithmically matched to learning styles that have proven to be successful with that user, tutors who are highly ranked for that or those same learning styles may also be automatically assigned to that same user.

The inventive system in practice may have a number of controls at the school or admin level, having a rules settings interface for educators and institutions the ability to control access, time usage, reports/statistics, award coins, skins, tools, and interact with other video, AR/VR, and/or curriculum solutions from within or pop in and out of the games or even pause it. In an embodiment of the invention, the delivery of rewards and/or summation of learning strands accomplished over a period of time may be tabulated. Groups such as schools, cities, school districts and state-wide entities may thus track performance of user students in short and long term scenarios. It may and track summary statistics of usage, improvement and successful trends and combinations of the recreational gaming, educational modules, and rewards.

In another embodiment of the invention, hints or clues regarding recreational gaming may be delivered as part of the educational module content. Such hints may be delivered by audio or video through the computing device of the user. Though the inventive system envisions creating original educational content and live/recorded teaching modules, it is similarly within the scope of invention to utilize existing educational content for example but not limited to brands such as channel/discover education videos, plato, lexia, odysseyware, acellus, kahoot, brainpop, lexia, splash math, edmentum, curiosity u, tied into planned educational strands so that every student user may enjoy an individual learning path generated by past successes, testing and other metrics selected by administrators of the inventive system. Looking are closely at the auto learning path, users may be required to watch short clips or answer questions or test for baselines throughout learning and create that learning path from within new and popular gaming and curriculum solutions. Applying science, reading, math, and history lessons as interspersed aspects during gaming, as signaled by themes, culture and historical facts of the game in questions, as part of a custom learning path for the user.

In an embodiment of the invention, users' avatar may be used both during the day and at home at night, and similarly for learning paths and subsets of excerpts for targeted instruction with the monitoring ability and/or hourly time limits applied inside or outside of school or learning institution. Thus, users may choose to invest gaming time within the inventive system using their school-based avatar after school to show gains and success the following day/week to friends and to receive further reward-based incentives as discussed infra. Promoting school/social based avatar may limit nighttime usage by gaining controls and working with parents of users. Participating schools implementing the inventive systems tend to have the largest (filtered) most robust computer networks and speeds in most cities and yet the network is unused ½ of every day and every weekend. The same period of unused time of those networks may thus be utilized with the inventive system while users are home. The present invention in practice utilizes unused network and data by making it available to students at home for-use by using district devices/wifi/lan/other data services as is desirable. Similarly, over summer, winter and spring breaks, the inventive system may continue to be utilized by users to continue advancing their educational skills and knowledge.

In an embodiment of the invention, educational service providers defray expenses such as purchasing hardware and accommodating additional server space by requiring users to see, promote, or answer/comment on commercials/ads before receiving said rewards or before starting up the recreational game. The social/advertising rights/cost may be implemented on a per student basis or on a per school basis, opening up valuable revenue stream which may be shareable with the educational service providers. In addition, cost associated fees and virtual coin purchasing within the system may create additional revenue streams for the school, gaming partners, and other service providers to share. Ads like shown on YouTube and others may pop up when a user re-enters the recreational game and/or upon retrieving coins or other rewards. In addition, ad or connection revenue may be created when others view user's content, utilizing twitch/Instagram/snapchat with filters and controls and students at school actually challenging their parents at work to learn, contest, or team collaboration during the day while friends, relatives, grandparents could watch remotely their success, comment, interact, and enjoy the fun they are having. Virtually, many stakeholders associated with the user, with permissions, may be involved with recreational game interaction, educational skills accomplishments and awards assembly, available up to daily or more basis as needed.

In yet another embodiment of the invention, educational service providers may utilize cumulative user counts and requested seats/clients to leverage volume discounts on game access fees, rewards, in-game currency, or other micro-purchases or fees otherwise chargeable to a user.

In another embodiment of the invention, different gaming setups/types of setting, standing, activity based, and others may create timed mandated body motion, or moving parts of the body, and AR and VR embodiments of the present invention create even more of a need to move and take a break from the gaming or overall system. As disclosed previously, administrative controls of requiring breaks from the system are well within the scope of the invention. When using AR and VR (especially with headsets) the need to control one user as well as manage many users will strongly exist while providing a management dashboard/app creating controls for usable student apps, times, with the ability to see and sharing student visors, and mandated curriculum deliverables balanced with gaming time. Students while wearing a VR type headset may also fall asleep or intentionally daydream. In an embodiment of the system, controls may also notify instructors and recognize unresponsive behavior indicative of a user sleeping or just in a daze accidentally or intentionally stalling/wasting time while using VR or AR headsets or enclosures. Monitoring this would require more than just watching eyes and provide important information. There further exists a need to also monitor for increased heart rates and charts/reports of how game/curriculum success and failures affects heart rate/pulse, breathing and temperature. It is possible for monitoring vital signs to see curriculum accomplishments/interaction and compare vitals when success/understanding versus not as a possible precursor to results/score. In an embodiment of the invention, sensors may be deployed within the users work space to detect tobacco use, talking, drinking, smoking, and vaping in VR/AR with headgear or enclosures. Such sensors may be set by administrators to alert multiple alerting types and management systems for single or multi user notifications by location and support many types of alerts by locations/zones/emails/text/alarms as well as audible or vibration reporting systems. Users using headgear at school, business, or home may have further need of notice of events such as visitors at the door or in other vicinity of the user. In another embodiment of the invention, stakeholders in the inventive system may opt for headgear or enclosure sensors to be linked to external security and IOT systems such as doorbell technologies, and other alarm events such as burglar alarms, paging, CCTV system, access control systems, bell or intercom systems, dog alerts, proximal screaming, fire alarm, phone, or other urgent notifying need or technology to respond properly. In the event one of the alarm events occurs, an alert is generated at the user's display, or accessed from VR systems through many ways like vibration, external microphone and sensors on headgear, pop up content which may interrupt or stop current activity and may be centrally controlled and distributed by wired or wirelessly to one or many devices or locations, or standardized emergency notification systems, for law enforcement or other emergency services. Such an inventive system may have rules for immediate emergency response in situations of user security, to predict and notify alarms with above parameters while gaming or using curriculum suite for immediate response by community, law enforcement, security, health or other emergency response.

In yet another embodiment of the inventive system, user students (like in gaming) are enabled to talk, tutor, teach, conference, and collaborate with one another while in the curriculum side or game side or combined side of new system while using or not using VR. Collaboration/tutoring may be shared with advanced controls and saved, catalogued, or recorded for viewing by others. Notes, comments, sketches, and other data or communications may be added to tutoring or collaboration by topic, question, strand for extra help and then viewable by others later or purchased with virtual coins and may be subject to adds. Rather than administering the same lesson to the same students through the many iterations and interactions with so many teachers, the inventive system may include controls to selectively record these events and communication and make available by topic/strand at any time. In this embodiment, users may then open up prior collaboration or previous tutoring sessions before initiating their specific educational module, question or subject and add more comments or sketches and review or rate new, prior, or historic topics. This embodiment of the invention may be setup to require user attempts to meet or pass a strand or standard before user is allowed or re-watch classroom instruction of that day. Students may utilize this interaction as a type of tutoring and team learning, from a fellow user student locally, another district, parent, or local or remote teacher. Positive reviews or rewards such as tokens/virtual/digital coins could be used as a tip or payment to successful mentors or teachers. In this embodiment, the system of comparing user success/knowledge first as a tutor to verify a minimum skill level to tutor a specific topic within a time allotment for each area, and then may have a pause or stop after the remote student surpasses or performs to that level of knowledge. Maintaining an active tutoring embodiment of this invention may provide a balance for users who have alternative learning styles.

### Improved Substitute Teaching With Targeted Virtual Learning

Another aspect of the current invention focuses upon the issue of integrating online learning tools and other software with real world classroom instruction. In an embodiment of the invention, a method for providing remote teacher is described herein. A remote teacher may comprise a regular teacher or a substitute teacher. When an educational service provider receives notice of an instructor's absence, it may solicit an instructor through its own portal or website, through 3^{rd} party employment companies (such as indeed.com), local, state or federal sites, or through other cooperative websites that may host such instructor opportunities. The educational service provider may post a notice of a short-term substitute position, listing information that could comprise the time(s) of the substitute class, the planned subject(s) of the substitute class, accreditation, system of textbooks involved, ratings by past students or parents or administrators, experience by subject or textbook system or online learning strand, and any other relevant information needed to appraise the opportunity, including a proposed, negotiable or standard fee for the assignment. Alternatively, the educational service provider may have built a database of pre-screened instructors using similar criteria and fields as noted above. The educational institute may filter by field, by way of example and note limitation, to only select the highest rated instructors, or to select by school size, location, or other relevant factors described herein. In another embodiment, the school leave system may be programmed according to preselected parameters or filters to solicit or select a substitute instructor upon receiving notice by a regular instructor of a planned or unexpected absence. In all these embodiments, educational institutes and the relevant stakeholders may be assured to select experienced teachers who are familiar with the current learning strands and work/testing solutions of those students or users. In an alternative embodiment, these solicitations approaches of an instructor or by an instructor may also be made available to kids who are home with illness, injury, suspension, or even those undergoing homeschooling.

Thus, the inventive method for delivering remote instruction in classrooms or homes may include identifying an instructor of interest through either embodiment. In an embodiment of the invention, the same network utilized by educational service providers may host a dynamic database of qualified instructors along with a listing of its own substitute assignments. An instructor of interest may create and update their profile to identify upcoming learning strands, or an interest in delivering a new learning strand instruction in the future. The instructor of interest may browse a listing of available classrooms or remote students needing instruction due to any number of circumstances. Once the instructor of interest identifies and selects a classroom, student(t)s or users (an audience), the instructor of interest may utilize multimedia tools to capture instructional audio, video and interactive screen sharing to stream the instruction of interest to the audience.

In an embodiment of this aspect of the invention, an interactive recording/streaming mount may be utilized in the center of a room at the ceiling, the mount offering tracking, height adjustment, audio, zooming and other variables controlled through the instructor portal or a remote A/V portal. The mount could be retrofitted over existing cameras or projectors, and may be hard wired into LAN lines or transferred/streamed wirelessly through Bluetooth, wifi or other wireless transmission. Elmo type cameras, screen sharing, smartboard screens and other information sharing devices may be used by the instructor of interest to work out specific instruction to the audience. It is within the scope of the invention to use other tools that are not obstructed in view, overcome with ambient noise, or other distractions to the audience. The audience members may view the instruction by computing devices, phones, AR/VR devices, televisions, and other personal viewing devices that capture the instruction stream and deliver it to the audience members remotely.

In an embodiment of the invention, both instructor and audience may review the other to help create a ratings system that other interested instructors, administrators, parents, and/or audience members may use to determine their interest in selecting the instructor or the audience. In an embodiment of the invention, instructors or their employer institutions may be compensated for the delivery of the remote instructional services. Instructor rates may be higher for those with greater experience or high ratings, or for audiences with poor ratings. Rates may be also be tied to the ability to record and re-watch the delivered instruction, by “views” of the course, or by other metrics of success and value. If the instructor takes on a long term project and enjoys a highly-rated performance for the assignment, he or she may even become the teacher of record and qualify for additional days/hours worked towards retirement in an existing employment package. In situations where the instructors existing schedule is complementary rather than conflicting, instructor may also be teaching his or her own class at the same time as delivering instruction to a remote audience, or teach during a planning hour, or other openings during the day.

In an embodiment of the invention, school districts or other groups of schools or homeschool groups may purchase an access package for a time period of delivered instruction from an instructor or from groups of instructors. Schools or homeschool groups may also purchase delivered instruction a la carte for a need-based days of instruction, such as when a regular teacher is absent. In many of the embodiments described, instructors could remotely take attendance or perform other administrative tasks remotely and update the report of the delivered instruction with data requested by the school or audience groups.

An aspect of the current invention relates to existing 3^{rd} party online education providers. In an embodiment of the invention, the collective student database created by the inventive system and method is utilized to auto-enroll all students in a 3^{rd} party provider's set-up or user management. This embodiment further may comprise automatically matching or linking the 3^{rd} party's learning strands to the local education agency that is relevant to each student of the educational institution. Thus, the student profile and user interface dashboard may effectively link the student's classroom education path with the complementary learning strand offered by the 3^{rd} party provider. Thus, the student may engage his or her dashboard to supplement classroom lessons with the appropriate learning strand. In yet another embodiment of delivering remote instruction to users and other students, archived video of the substitute instructors, of tutors, or other streamed lessons arranged by the educational institute may be listed by 3^{rd} party websites and academic institutions to be accessed and catalogued along with their live instructors. Audiences could select and purchase the historical video on a subscription basis, or a la carte on demand, of similar learning strands, delivered by educational institute itself or by 3^{rd} party online education providers such as Acellus, Edmentum, Discovery, Study Island and Khan. Many educational institutions already subscribe to one or more of the 3^{rd} party providers and make available such content to students. In another embodiment of the invention, the substitute instructor may have training in a 3^{rd} party online education provider that is not offered by education institute hiring the substitute instructor. An inventive method of collaboration with those 3^{rd} party providers is thus disclosed: A substituting educational institute has a subscription to 3^{rd} party provider “A.” The students in the class(es) of the substitute assignment are given temporary passes to 3^{rd} party online educational providers “B” and “C” for which the substitute instructor is trained or experienced. The substitute instructor may then give additional instruction on using the alternative 3^{rd} party online education providers and expose students to a new learning thread. The students then as individuals or through lobbying the school may then subscribe to the alternative 3^{rd} party provider.

In another embodiment of the invention, the secure storage locker of each student as described infra may further, or separately comprise copies of the student's accomplished curriculum in addition to his or her grades and other academic information. The secure storage locker may further comprise learning strands accomplished through 3^{rd} party online education providers, links to archived lessons developed through substitute, regular teaching or tutorial lessons that have been accomplished by student. In another embodiment of the invention, remedial online classes may be arranged for students of an educational institute or other group. The remedial classes may be filtered and notified to students based upon past class grades or performances, upon scholarship profiles that need to be attained, or upon other filters determined by the educational institute or by the student. The student may engage the remedial class from his user dashboard and interface, or may simply review the remedial class opportunity and launch from another location or website. The remedial class may be delivered from archived lessons created from this inventive system, from 3^{rd} party online education providers, or from other sources certified by the education institute attended by the student. In an embodiment of the invention, the system may automatically create a remedial learning path using the combination of sources application to the educational institute. By example and not limitation, a student may view past video lessons, live substitute assignments from other educational institutes, receive live tutorial lessons, and complete 3^{rd} party online educational service provider learning strands. Upon successful completion of the remedial class, the student's grade may be changed in the digital secure storage locker and updated to any other location where a certified record of the students grades may be located.

In practice, these embodiments of delivering instruction to audiences may resemble the following example, though many other scenarios are well-within the scope of the invention. A regular teacher will be missing day or days of school. He or she inputs (or the system accesses) the classes' basic information and extended learning strands such as lesson plans that he or she would be teaching during the absence, and notifies personnel/leave system of the affected educational service provider/institute. Basic information may comprise at a minimum the subject school, class grade, subject, and other high level fields of study. Background information prepared by the regular teacher may be attached to class and available to download or upload. The basic information is then uploaded to a shared center or utilizes existing data accessible by every other school and teacher using or part of the system, through a personal device software application, website where interested instructors may then select or accept the posted invite or choose the link accepting the substitute assignment.

Interested instructors who either already have video to stream or are teaching that exact subject that day would then select and accept the notice/invite and then stream their lesson to one or many classrooms. Interactive discussions from audience members may be allowed if desired and enabled by having a similar a/v mount in the audience venue, along with a system including software to analyze streaming video and other functions discussed infra. In an embodiment of the invention, an audio visual camera mount and its system may include sensors, other video processing software, or other motion recognition known in the arts. The mount system may be programmed to establish a baseline visual profile of the audience members. The mount system may note a change of an audience member who raises their hand, signaling or otherwise noting the instructor that the audience member requests attention for a question or comment. After the student or user signal is recognized, the mount system may comprise a camera that may orient towards the student or user who signals. Other measures to relay communication between the audience member and instructor may deployed as known in the arts, including a software application deployed on a mobile phone or computing device. In yet another embodiment to improve the personal exchanges between users or audience members and instructors, some or all attendees may be equipped with wearable beacons, both standalone as in a lanyard or and within personal cell phones or other electronic devices whose location signals may be linked to the inventive system. Thus, the mount system may move along x, y, z axes, orienting towards an audience member or instructor by an assigned controlling user. The controlling user, such as an instructor or other admin, may determine who in the classroom needs the focus of the instruction session, enabling more direct video and audio interactions with users or students in the instruction session.

In another embodiment, approved students may qualify as an instructor, an instructor assistant, tutor or other role for the audience, either in the instructor room or in the audience venue. Thus, those approved students may receive credits, rewards or other incentives. Reviews and ratings may then be assessed to the instructor/audience/approved student and kept as a record in the users' respective files.

Other functions may be hosted and accomplished with the inventive system as hosted locally within the educational institute or off site for tutoring purposes. Discussion boards may be organized to allow students to experience peer interaction and questions; open questions may be transferred into postings or solicitations for further and continued tutoring opportunities. Students or parents may be paying the instructor(s) for helping tutor them and has many controls for recording, collaboration, reviews, and security settings for protecting students and teachers. To ensure consistent quality of instruction and client, video and audio of incidents may be captured by stakeholders to report discipline issues of students or instructors, though their user faces may be blurred on the delivering or receiving end. Such tutorial opportunities may work independent of substitute assignments, integrated online learning, or along with the shared instruction. Similar to the payment structure discussed for substitute instructors, school districts or other audience groups may pay the tutor instructor or instructor's home school district a fee for every substitute assignment, of which multiple sessions may occur simultaneously. Fees may be standardized by subject, district or other region, time, or other factors, including but not limited to the number of concurrent users or sessions.

In an embodiment of the invention, the instruction delivery site's data gathering equipment, software and instructor inputs may reporting actions to the educational institute's administration, teacher, or parent of students receiving instruction for any disciplinary or attendance issues, as well as overall audience participation and work performance.

Educational institutes may accrue data from the various embodiments of the invention discussed, and utilize such data to create reports automatically or manually. Reports may include teacher absences that create the substitute assignment, the overall cost for filling the substitute assignment, who is teaching the audience members, their credentials, and ratings for those delivered instructional services, as well as other data relating to the cost and value of these virtual substitutions Parents or guardians may be automatically sent a report when a substitute assignment takes place for their students, including but not limited to the substitute instructors information, the lessons taught, and access to the video of the instruction saved or archived.

In an embodiment of the invention, other stakeholders may view streams of the substitute assignment at the time the substitute instructor delivers the instruction or thereafter on an archive. A matrix of streams may be available for stakeholders to evaluate the instructor or students. For example, administrators and or principals could also watch one or many active streams or historical classes for a type of classroom monitoring and rating of the substitute.

Payments known in the arts may apply to compensate substitute instructors, including digital currency/virtual money. In another embodiment of the invention, the inventive software may include a payroll function that tracks the hours spent by the instructor, alternatively compares hours spent to bid price and auto bills the educational institute or other customer. The payroll function may include a payment transaction process tied into other embodiments of the software application and/or business process, especially as having points of approval, for instance, at the controller applications access at the instructor side and/or the instruction group side. Payments could be set, for example to auto transfer daily from schools at end of day, so that existing payment processing hubs may transfer funds from an account held by the payor to one held or managed by the payee. If the substitute instructor has regular lessons, tutorial sessions or other streamable content, those lessons may also be saved and be categorized and future royalties paid to the substitute instructor or his or her own school district.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

What is claimed is:

1. A method for delivering remote instructional services for educational institutes and learning groups, the method comprising:
Setting qualifications a substitute assignment of instruction at the educational institute or group;
Soliciting instruction services from at least one qualifying instructor for a substitute assignment;
Achieving an agreement with the qualifying instructor to deliver a substitute assignment to at least one audience member;
Arranging the delivery of instructional services by instructors to at least one audience member by video streaming;
Paying a fee for the instruction to the qualifying instructor or its agent.

2. The method of claim 1, further comprising the step of:
Positioning an a/v mount at a center of the instructor classroom the a/v mount configured to track to a person of interest in the classroom in a x, y or z axis;

3. The method of claim 1 further comprising the step of:
Enabling a rating system of the instructors and audience members.

4. The method of claim 1 further comprising the step of:
Cataloging the delivery of instructional services by subjects.

5. The method of claim 1 further comprising the step of:
Programming the automatic selection of the qualifying instructor based upon preselected filters determined by the educational institute or group.

6. The method of claim 5, whereby the step of programming the automatic selection is triggered by a notice of absence by a regular instructor of the educational institution.

7. The method of claim 1 further comprising the step of:
Providing a temporary pass to utilize a 3^{rd} party online education service provider that the qualifying instructor has training.

8. A method for creating a remedial online class, the method comprising:
Creating a digital record of a student's past classes taken;
Notifying a student of a remedial class opportunity based upon filters of past classes taken by student;
Accessing at least one learning module;
Updating the digital record of the student according to the successful completion of the remedial class.
